(19) United States
(12) Patent Application Publication
(10) Pub. No.: US 2024/0106900 A1
(43) Pub. Date: Mar. 28, 2024

(54) METHODS AND APPARATUS TO ADD A NON-NATIVE NODE TO A CLUSTER

(71) Applicant: Intel Corporation, Santa Clara, CA (US)

(72) Inventors: Kannan Babu Ramia, Bangalore (IN); Palaniappan Ramanathan, Bengaluru (IN); Deepak S, Bangalore (IN); Bhavik Dhandhalya, Bhavnagar (IN)

(21) Appl. No.: 18/533,125

(22) Filed: Dec. 7, 2023

(51) Int. Cl. H04L 67/14

(52) U.S. Cl. CPC H04L 67/14

(57) ABSTRACT

Methods, apparatus, systems, and articles of manufacture to add a non-native node to a cluster are disclosed. An example apparatus includes programmable circuitry to at least one of instantiate a first agent to interface with a management application to obtain a request from a node to join a cluster of nodes, the first agent to interface with the management application using a first protocol; and instantiate a second agent which employs a second protocol different than the first protocol: responsive to an authentication of an identity credential of the node, obtain a secret credential; and cause the first agent to pass the secret credential to the node via the management application to enable the node to join the cluster of nodes.

### FIELD OF THE DISCLOSURE

This disclosure relates generally to distributed networks and, more particularly, to methods and apparatus to add a non-native node to a cluster.

### BACKGROUND

A distributed network (sometimes referred to as a cluster network) is a network of computing devices (e.g., nodes and servers) that work together to execute one or more tasks. The computing devices in such a network may perform different portions of the one or more tasks (e.g., to increase speed and/or performance) and/or may perform the same portion(s) of the one or more tasks (e.g., for high availability to mitigate problems when one or more nodes fail). A group of nodes, which may be managed by a central plane node, is referred to as a cluster or fleet.

### BRIEF DESCRIPTION OF THE DRAWINGS

FIG. 1 is a block diagram of an example distributed network illustrating the addition of a requesting non-native node into a cluster.

FIG. 2 is a block diagram of an example implementation of the control plane node of FIG. 1.

FIG. 3 is a flowchart representative of example machine readable instructions and/or operations that may be executed, instantiated, and/or performed by programmable circuitry to implement the example control plane node of FIG. 2.

FIG. 4 is a block diagram of an example processor platform including programmable circuitry structured to execute, instantiate, and/or perform the computer readable instructions and/or perform the example operations of FIG. 3 to implement the control plane node of FIG. 2.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In some applications of distributed networks, computing devices can analyze information from edge devices (e.g., sensors) and relay the information to other edge, fog, central, cloud, and/or node circuitry to perform tasks (e.g., related to automation optimization, data processing, visualization of the analyzed data, etc.). The data analysis circuits (e.g., cloud circuitry) can respond to issues related to one or more objects detected and/or tracked by the edge-based devices in real-time or substantially real-time. Such nodes, devices and/or systems may include a cluster or fleet of nodes and/or compute nodes that can co-operatively process a workload to efficiently execute functions, process data, etc.

Cluster orchestrators are used to deploy workloads to nodes within a cluster of nodes and monitor performance. A cluster orchestrator manages workloads and/or services across multiple nodes. Known orchestrators run protocols that have been developed to communicate with nodes using shared protocols for identity verification, secure onboarding, etc. Such shared protocols are referred to herein as “native protocols.” A native protocol is a protocol that a particular node, orchestrator, and/or the like is intended to utilize. Nodes that correspond to the same (e.g. native) protocol can be included in a cluster that is managed by an orchestrator that also utilizes the native protocol. New native nodes to be added to a system can be seamlessly added to a cluster to execute workloads based on instructions from an orchestrator because such new nodes operate with the native protocol.

However, it is sometimes desirable to update a cluster of a system to include one or more new nodes that run first (e.g., non-native) protocols that are different from a second (e.g., native) protocol(s) of the orchestrator. Such nodes are referred to herein as non-native nodes and/or third-party nodes. For example, a user and/or administrator may purchase and/or want to add the non-native node circuitry to a cluster controlled by a native system that runs protocols different from the non-native protocols of the third party node. The difference in protocols may prevent the third party node from being added to the cluster. In known systems, third party nodes may need to install software native to the orchestrator to be able to communicate and/or operate with the orchestrator. In some known systems, identities of the third party nodes need to be manually applied to the third party nodes (e.g., by having a user and/or administrator provide a generated identifier). Therefore, adding a non-native node to a cluster is sometimes not possible in known system and/or may only be accomplished with manual intervention by skilled technicians.

Examples disclosed herein allow a non-native node to enter a native cluster without needing to have an identity manually provided to the non-native node and without forcing the non-native node to install native software (e.g., without modifying the non-native node (e.g., to include and/or operate via the native protocols of the cluster)). Examples disclosed herein provide a single dashboard or control for management of clusters with native nodes and/or non-native nodes (e.g., nodes from different providers and/or that use different protocols).

To allow for seamless addition of a third party (e.g., non-native) node into a native cluster, examples disclosed herein include a control plane node that manages the addition of third party node(s) into the cluster in a zero trust environment (e.g., where one or more third party management systems verify that the third party node is legitimate). The control plane node of some such examples includes multiple virtual execution environments (e.g., containers, virtual machines, etc.) respectively corresponding to different third party protocols. Each virtual execution environment includes a third party management application and side-car identity agent. The third party management application communicates with one or more corresponding third party nodes (e.g., to obtain requests and/or forward credentials). The side-car identity agent communicates with the third party management application to obtain identity credentials for the third party node from the third party management application based on the third party protocols. Additionally, the side-car identity agent of some examples forwards the identity credentials provided via a request in a protocol native to the control plane node. In this manner, a control entity (e.g., which operates in the native protocol of the control node) can verify the identity of the third party node by working with an orchestrator and/or identity provider node. Thus, in some examples, requests from a non-native node to be included in a cluster via the third party management application using third party protocols and the side car agent transmits a request to a control identity agent using the native protocols to verify the identity of the third party node. After verification, the control identity agent requests a secret (e.g., private, secure, encrypted, etc.) credential (e.g., a key, a certificate, a token, etc.) from a virtual execution environment (VEE) orchestrator layer server. After obtaining the secret credential, the control identity agent transmits the secret credential to the third party node via the sidecar agent (e.g., also referred to as a container sidecar, a virtual execution environment sidecar, etc.) and the third party management application to allow the third party node to be part of the cluster. The secret credential allows the third party node to access the VEE orchestrator layer server and, thus, to become part of the cluster. Because the side-car identity agent acts as a middleman translator that communicates with the third party management application using the third party protocol(s) and communicates with the control identity agent using the native protocol(s), the third party nodes request to join the cluster can be processed, be verified, and the requesting non-native node can obtain a secret credential without being modified (e.g., without installing native software to run the native protocol(s) to communicate with the control plane node).

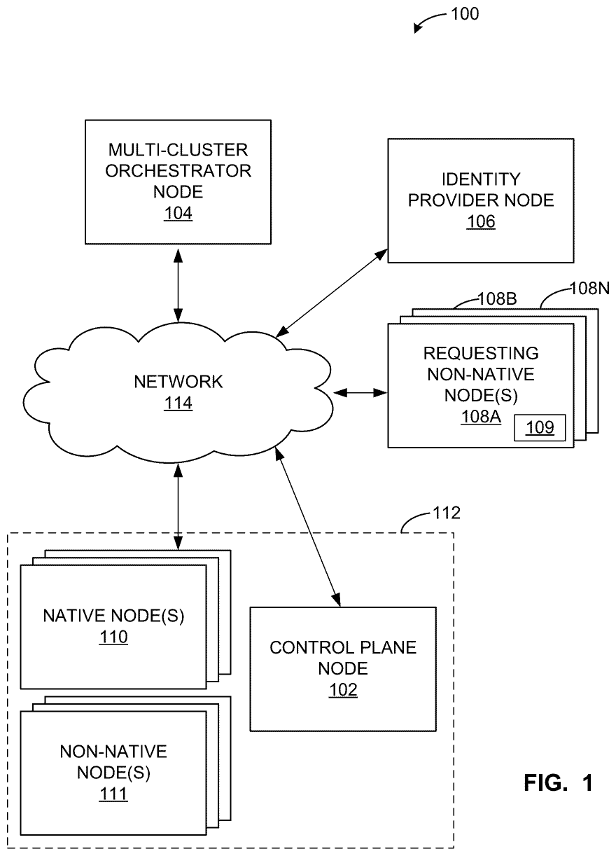

FIG. 1 is a block diagram of an example distributed network 100 in which third party nodes are automatically added into a cluster or fleet. The example distributed system 100 of FIG. 1 includes an example control plane node 102, an example multi-cluster orchestrator node 104, an example identity provider node 106, example requesting non-native nodes 108A-108N, an example third party agent application 109, an example cluster 112 (including 1 to N native nodes 110, zero to N non-native nodes 111, and the control plane node 102), and an example network 114. There may be any number of nodes (e.g., any number of control plane nodes, orchestrator nodes, identity provider nodes, native nodes, non-native nodes, and/or third party nodes) and/or clusters of nodes in the distributed system 100. Additionally, in some examples one or more nodes of the distributed system 100 can be combined. For example, the control plane node 102 and the multi-cluster orchestrator node 104 may be implemented in a single node, the multi-cluster orchestrator node 104 and the identity provider node 106 can be implemented in a single node, etc.

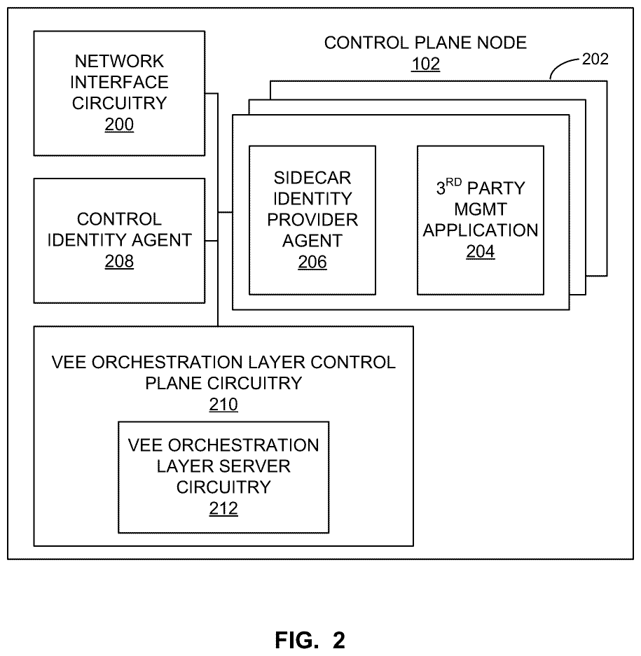

The example control plane node 102 of FIG. 1 may be a personal computer, a tablet, a server, a mobile device, and/or any other type(s) of computing device. The control plane node 102 obtains request(s) from one or more of the requesting non-native nodes 108A-108N to be part of the cluster 112 of the native nodes 110 (e.g., nodes that operate using the same native protocols as the control plane node 102). The cluster 112 may also include the non-native nodes(s) 111, as shown in FIG. 1. An example request includes identity credentials corresponding to the requesting non-native node 108A-108N seeking admission to the cluster. The control plane node 102 instantiates one or more virtual execution environments that are respectively able to communicate according to respective protocols of the requesting non-native nodes 108A-108N and convert the information from the requesting non-native nodes 108A-108N into a native protocol for handling the request(s) to join the cluster 112. Additionally, the control plane node 102 verifies identity credentials for the requesting non-native nodes 108A-108N. For example, the control plane node 102 transmits the identity credentials provided via a request to the multi-cluster orchestrator node 104 to verify the identity credentials, as further described below. After obtaining verification of the identity of the requesting non-native node(s) 108A-108N from the multi-cluster orchestrator node 104, the control plane node 102 generates a secret credential (e.g., a token, a certificate, a key, etc.). The control plane node 102 forwards the secret credential to the corresponding non-native node 108A-108N. As further described below, the corresponding non-native node 108A-108N subsequently joins the cluster 112 and accesses a virtual execution environment orchestrator layer server of the control plane node 102 using the secret credential. An example implementation of the control plane node 102 is further described below in conjunction with FIG. 2.

The orchestrator 104 of FIG. 1 manages the identity and secure onboarding of the nodes 110, 111 into the cluster 112 so that the control plane node 102 can work with the local nodes 110, 111. orchestrates and/or manages control of the nodes 110 in the cluster 112 (e.g., including one or more non-native nodes 108A-108N that have joined the cluster 112). As described above, after a request from one of the requesting non-native nodes 108A-108N to join the cluster 112, the control plane node 102 sends a request to verify an identity credential (e.g., a token, a certificate, a key, etc.) corresponding to the requesting one of the requesting non-native nodes 108A-108N to the orchestrator 104. The orchestrator 104 communicates the identity credential to the identity provider node 106. For example, the identity provider node 106 verifies the identity credential to verify that the requesting non-native node 108A-108N is authentic using an API-based mechanism. In some examples, the orchestrator 104 can have its own identity verification mechanism rather than or in addition to relying on the identity provider node 106. In the illustrated example, the multi-cluster orchestrator node 104 obtains an indication that the identity credential is authentic and/or verified or an indication that the identity credential is not authentic and/or verified.

Additionally, the orchestrator 104 of FIG. 1 determines if a third party management application (also referred to herein as a non-native management application) should be installed (e.g., packaged and/or deployed to a virtual execution environment) on a controller node. For example, a user, administrator, and/or manufacturer may determine that it would like to be able to include third party and/or non-native nodes corresponding to a particular non-native protocol into one or more clusters managed by the control plane node 102. In such an example, the user, administrator, and/or manufacturer, may provide the appropriate third party and/or non-native management application and/or information related to the third party to the multi-cluster orchestrator node 104 to check the third party management application corresponding to the particular third party for permission violations.

When deploying a non-native management application to the control plane node 102, the multi-cluster orchestrator node 104 determines if the non-native management application and/or the corresponding non-native protocol is associated with permission violations. Permission violations may include determining that the cluster 112 is not correct for a specific third party management application due to the unavailability of required access license, the license being expired, etc. If the example multi-cluster orchestrator node 104 determines that the non-native management application is not associated with permissions violations, the multi-cluster orchestrator node 104 can deploy the non-native management application to the control plane node 102 to permit communication with non-native nodes that employ third party and/or non-native protocols. For example, the multi-cluster orchestrator node 104 may deploy a virtual execution environment such as a container or virtual machine, etc. in which the non-native management application operates. A given non-native application will correspond to a particular non-native protocol. Thus, if a cluster is to permit multiple non-native nodes that respectfully employ different protocols, multiple different instances of third part management applications may operate on the control plane node to enable joining by nodes of the corresponding non-native protocols, respectively.

Additionally, the multi-cluster orchestrator node 104 deploys a sidecar identity provider agent into the VEE. The sidecar identity provider agent is a translator capable of communicating in both a non-native protocol and a native protocol, as further described below. The sidecar identity provider agent may be implemented as a software routine executing in a virtual execution environment such as a virtual machine, a container, etc. In some examples, the multi-cluster orchestrator node 104 deploys the third party management application and the corresponding sidecar identity provider agent together in the same virtual execution environment. In other examples, the third party management application and the sidecar identity provider agent are deployed in separate VEEs.

The requesting non-native nodes 108A-108N of FIG. 1 are nodes that are capable of executing workloads and/or portion(s) of workloads. The requesting non-native nodes 108A-108N may be computing devices, servers, mobile devices, and/or any type(s) of device(s). In FIG. 1, the requesting non-native nodes 108A-108N utilize different protocols (e.g., communication protocols, key handling protocols, etc.) than the native protocols of the control plane node 102. This may be due to many factors. For example, the requesting nodes may be manufactured by one or more different manufacturers then the manufacturer of the native control plane node 102. In some examples, the requesting non-native node 108A is not manufactured by the same manufacturer of one or more of the other requesting non-native nodes 108B-108N. Accordingly, the requesting non-native node 108A may implement different protocols (e.g., communication protocols, key handling protocols, etc.) than the protocols of the requesting non-native node(s) 108B-108N. The non-native nodes 108a-108N include the example third party agent application 109 (also referred to as a non-native agent application) that is able to communicate with a third party management application of the control plane node 102 using the non-native protocols. Although multiple requesting nodes are shown, only one such node may be present and/or one or more such node(s) may be requesting to join at any given time.

When one of the requesting non-native nodes 108A-108N of FIG. 1 is to join the cluster 112, the corresponding non-native node 108A-108N transmits a request to the control plane node 102 using the non-native protocols of the non-native node. The request includes identity credentials of the corresponding non-native node 108A-108N. After verification, the corresponding non-native node 108A-108N obtains a secret credential (e.g., key, token, certificate, etc.) from the control plane node 102. The corresponding non-native node 108A-108N of the illustrated example executes a join API call using the secret credential to access a VEE orchestration layer server of the control plane node 102. After the VEE orchestration layer server of the control plane node 102 is accessed using the secret credential, VEE orchestration layer control plane circuitry joins the requesting non-native node into the cluster 112. Additionally, accessing the VEE orchestration layer server of the control plane node 102 allows the requesting non-native node 108A-108N to obtain instructions from the VEE orchestration layer control plane circuitry, access resources of the cluster, access portion(s) of workload(s), access information from the VEE orchestration layer control plane circuitry, etc.

In some examples, when the system is first implemented, the native nodes(s) 110 are implemented into the cluster 112 (also referred to as a fleet). However, if a user or administrator desires to increase the number of nodes in the cluster 112 to increase the speed, resources, etc. for executing workloads, the user and/or administrator may purchase and/or implement the non-native nodes 108A-108N. The user and/or administrator may purchase the third party nodes, as opposed to native nodes, 108A-108N based on price, convenience, the characteristics of the non-native nodes 108A-108N, etc. Thus, the control plane node 102 can determine that one of the non-native nodes 108A-108N is attempted to join the cluster 112 and include the one of the non-native nodes 108A-108N into the cluster 112 after verification from the multi-cluster orchestrator node 104 without requiring the requesting non-native node 108A-108N to modify itself to join the cluster 112.

The example network 114 of FIG. 1 is a system of interconnected systems exchanging data. The example network 114 may be implemented using any type of public or private network such as, but not limited to, the Internet, a telephone network, a local area network (LAN), a cable network, and/or a wireless network. To enable communication via the network 114, the example nodes 102, 104, 106, 108A-108N, 110 include a communication interface that enables a connection to an Ethernet, a digital subscriber line (DSL), a telephone line, a coaxial cable, an optical fiber connection, and/or any wired or wireless connection. In some examples, the nodes 102, 104, 106, 108A-108N, 110 are communicatively connected via the example network 114. Accordingly, information transmitted and/or received between the nodes 102, 104, 106, 108A-108N, 110 is carried by/through via the network 114. In some examples, direction connection outside the network 114 may additionally or alternatively be present between two or more of the nodes 102, 104, 106, 108A-108N, 110.

FIG. 2 is a block diagram of an example implementation of the control plane node 102 of FIG. 1. The example control plane node 102 of FIG. 2 includes example network interface circuitry 200, a plurality of example virtual execution environments 202 respectively hosting an example third party management (MGM) application 204 (also referred to as non-native management application 204), an example sidecar identity provider agent 206 and an example control identity agent 208, example virtual execution environment (VEE) orchestration layer control plane circuitry 210, and example VEE orchestration layer server circuitry 212.

The example network interface circuitry 200 of FIG. 2 communicates with other nodes via the example network 114 of FIG. 1. For example, the network interface circuitry 200 may obtain request(s) from one or more of the requesting non-native nodes 108A-108N to join the cluster 112. Additionally, the network interface circuitry 200 may obtain identity verification(s) from the multi-cluster orchestrator node 104. Additionally, the network interface circuitry 200 may transmit request(s) to verify the authenticity of the non-native node to the multi-cluster orchestrator node 104. Additionally, the network interface circuitry 200 may transmit secret credentials to the requesting non-native nodes(s) 108A-108N once approved to join the cluster 112.

The virtual execution environments 202 of FIG. 2 can be implemented by a container(s) and/or virtual machines, etc. that are deployed to the control plane node 102 to provide an operating system in which software can execute. Such software operating in the VEE may communicate with and/or translate information from the requesting non-native node(s) 108A-108N based on non-native protocols. For example, the virtual execution environments 202 each host a third party management application 204 and the sidecar identity provider agent 206. Alternatively, the third party management application 204 and a sidecar identity provider agent 206 can be implemented in two separate virtual execution environments.

The third party management application 204 of FIG. 2 is executed within a virtual execution environment to communicate with the requesting non-native node 108A seeking to join the cluster using the third party and/or non-native protocol used by the requesting non-native node 108A. For example, the third party management application 204 can obtain a request to join the cluster 112 from the requesting non-native node 108A. The request may include identity credentials. The third party management application 204 may verify that the requesting non-native node 108A is legitimate and/or authentic. Although the third party management application 204 verifies the requesting non-native node 108A, in a zero trust environment, the third party verification may not be trustworthy. Thus, the control plane node 102 performs a native verification protocol using the identity provider node 106 to ensure that the requesting non-native node 108A will not cause harm to the system. After verifying that the requesting non-native node 108A is legitimate and/or authentic, the third party management application 204 transmits the join cluster request and/or the identity credentials of the requesting non-native node to the sidecar identity provider agent 206 using the non-native protocol. After the control identity agent 208 verifies, using the identity provider node 106, that the requesting non-native node 108A is legitimate and/or authentic, the control identity agent 208 transmits a secret key to the third party management application 204 via the sidecar identity provider agent 206. In this manner, the requesting non-native node 108A does not need additional software and/or does not need to be modified be able to communicate with the control plane node 102 to request joining the cluster 112 and/or to receive a secret token to join the cluster 112.

The sidecar identity provider agent 206 of FIG. 2 can execute a virtual execution environment to translate information between the non-native protocols and the native protocols. In this manner, the sidecar identity provider agent 206 can obtain a request to join the cluster 112 from the third party management application 204 based on the non-native protocols and request secret credentials from the control identity agent 208 based on native protocols. Each virtual execution environment of the virtual execution environments 202 corresponds to a different non-native protocol. For example, if the requesting non-native node 108A implements a first non-native protocol and the requesting non-native node 108B implements a second non-native protocol, the virtual execution environments 202 can include (a) a first virtual execution environment with a first third party management application and a first sidecar identity provider agent for the first requesting non-native node 108A and (b) a second virtual execution environment with a second non-native management application and a second sidecar identity provider agent for the second requesting non-native node 108B. The sidecar identity provider agent 206 has an in-built shared secret to ensure secure communications with the control identity agent 208. The sidecar identity provider agent 206 has permissions to communicate with the control identity agent 208 to receive secret credentials (e.g., tokens, keys, certificates, etc.). The sidecar identity provider agent 206 can provide the secret credentials to the third party management application 204 on a localhost that the third party management application 204 can consume or provide to the corresponding non-native node 108A-108N.

The control identity agent 208 of FIG. 2 can execute a virtual execution environment to operate according to native protocols. The control identity agent 208 obtains requests from sidecar identity provider agent(s) 206 from one or more virtual execution environments 202 to have a non-native node join the cluster 112. After obtaining the request, the control identity agent 208 verifies the identity credentials included in the requests by transmitting the identity credentials to the multi-cluster orchestrator node 104. After receiving an indication that the requesting non-native node(s) 108A-108N are authentic, verified, and/or legitimate, the control identity agent 208 requests a secret credential (e.g., a token, a key, a certificate, etc.) from the virtual execution environment orchestration layer control plane circuitry 210. The secret credential can be used by the requesting non-native node 108A-108N to access the virtual execution environment orchestration layer server circuitry 212 to join the cluster 112. After obtaining the secret credential, the control identity agent 208 forwards the secret credential to the sidecar identity provider agent 206 to be transmitted to the requesting non-native node 108A-108N via the third party management application 204. The control identity agent 208 exposes a secure representational state transfer (REST) API and/or remote procedure call (gRPC or RPC) APIs to provide credentials (e.g., keys, tokens, certificates, etc.) to the sidecar identity provider agent 206.

The virtual execution environment orchestration layer control plane circuitry 210 of FIG. 2 manages the worker nodes in the cluster 112 (e.g., including the requesting non-native nodes 108A-108N after joining the cluster 112). In some examples, the virtual execution environment orchestration layer control plane circuitry 210 runs on multiple computers to provide fault-tolerance and/or high availability. In some examples, the virtual execution environment orchestration layer control plane circuitry 210 includes the virtual execution environment orchestration layer server circuitry 212, an etcd, a scheduler, a controller, a virtual execution environment orchestration layer agent, etc. The etcd is a consistent and highly-available key value store that stores backing information for all cluster data. The scheduler monitors and/or manages newly created pods (e.g., sets of running virtual execution environments in the cluster 112) with no assigned node and selects a node for the newly created pods to run on. The controller runs controller processes (e.g., monitoring and/or responding when a node does down, monitor for one-off tasks, populate EndpointSlice objects, create service accounts for new namespaces, etc.). The virtual execution environment orchestration layer agent can run on each node in a cluster to make sure that virtual execution environments are running in a pod.

The virtual execution environment orchestration layer server circuitry 212 of FIG. 2 generates secret credentials. In some examples, the virtual execution environment orchestration layer server circuitry 212 is an application programming interface (API) server. The virtual execution environment orchestration layer server circuitry 212 is a front end for the virtual execution environment orchestration layer control plane circuitry 210. When one or more of the requesting non-native nodes 108A-108N want to join the cluster 112, the one or more of the requesting non-native nodes 108A-108N need access to the virtual execution environment orchestration layer server circuitry 212. To allow a non-native node to access the virtual execution environment orchestration layer server circuitry 212, the virtual execution environment orchestration layer server circuitry 212 generates a secret credential after the non-native node has been verified. After the secret credential is generated, the virtual execution environment orchestration layer control plane circuitry 210 forwards the secret credential to the control identity agent 208 to send to the non-native node (e.g., via the virtual execution environment 202 corresponding to the third party of the non-native node). The secret credentials may be software-based and/or hardware based. For example, the virtual execution environment orchestration layer server circuitry 212 can generate a credential using a root of trust, a trusted platform module, cryptographic techniques, and/or any other technique for generating secret credentials.

While an example manner of implementing the control plane node 102 of FIG. 1 is illustrated in FIG., one or more of the elements, processes, and/or devices illustrated in FIG. 2 may be combined, divided, re-arranged, omitted, eliminated, and/or implemented in any other way. Further, the network interface circuitry 200, the virtual execution environments 202, the third party management application 204, the sidecar identity provider agent 206, the control identity agent 208, the virtual execution environment orchestration layer control plane circuitry 210, the virtual execution environment orchestration layer server circuitry 212, and/or, more generally, the control plane node 102 of FIG. 2, may be implemented by hardware alone or by hardware in combination with software and/or firmware. Thus, for example, any of the network interface circuitry 200, the virtual execution environments 202, the third party management application 204, the sidecar identity provider agent 206, the control identity agent 208, the virtual execution environment orchestration layer control plane circuitry 210, the virtual execution environment orchestration layer server circuitry 212, and/or, more generally, the control plane node 102 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the control plane node 102 of FIG. 2 may include one or more elements, processes, and/or devices in addition to, or instead of, those illustrated in FIGS. 1 and/or 2, and/or may include more than one of any or all of the illustrated elements, processes, and devices.

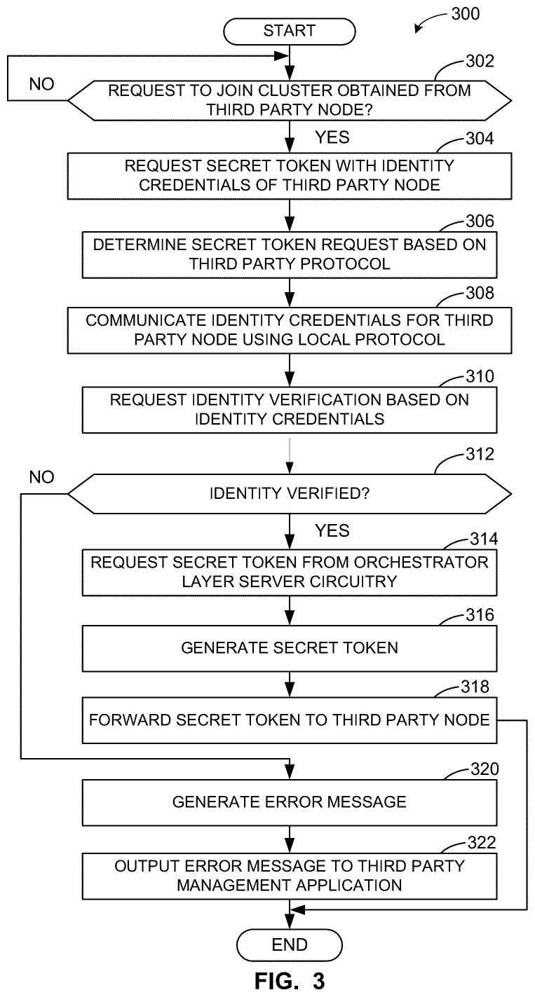

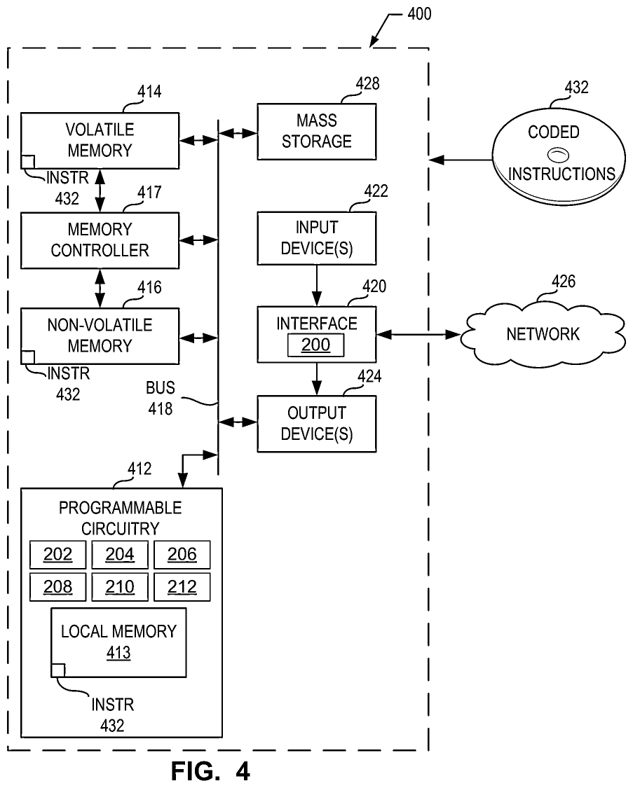

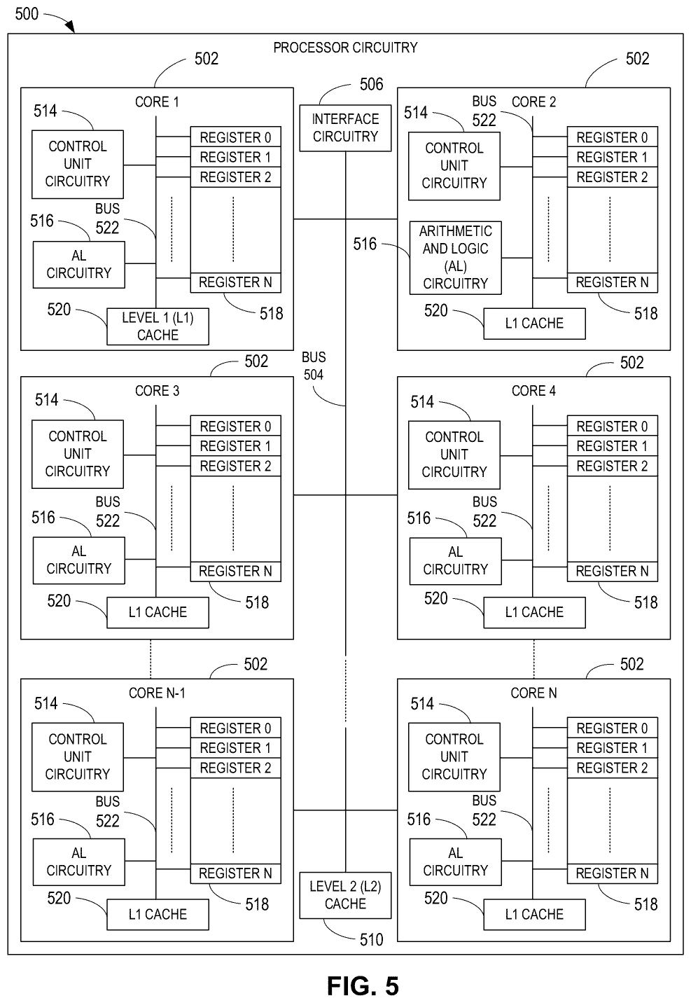

Flowchart(s) representative of example machine readable instructions, which may be executed by programmable circuitry to implement and/or instantiate the control plane node 102 and/or the multi-cluster orchestrator node 104 of FIG. 2 and/or representative of example operations which may be performed by programmable circuitry to implement and/or instantiate the control plane node 102 of FIG. 2, is shown in FIG. 3. The machine readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the control plane node 102 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, Go Lang, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 3 is a flowchart representative of example machine readable instructions and/or example operations 300 that may be executed, instantiated, and/or performed by programmable circuitry(ies) to join a non-native node to the cluster 112 of native node(s) 110. For example, the example operations 300 may be executed, instantiated, and/or performed by the control plane node 102 of FIG. 2. In the example of FIG. 3, the flowchart is described in conjunction with adding the requesting non-native node 108A to the cluster 112. However, the flowchart may be described in conjunction with any non-native node (e.g., including one or more of the requesting non-native node(s) 108B-108N of FIG. 1). Additionally, although the flowchart of FIG. 3 is described in conjunction with tokens, FIG. 3 can be described in conjunction with certificates, keys, and/or any other credential. The example machine-readable instructions and/or the example operations 300 of FIG. 3 begin at block 302, at which the third party management application 204 determines if a request to join the cluster 112 has been obtained from the requesting non-native node 108A via the network interface circuitry 200. The request includes identity credentials of the requesting non-native node 108A.

If the third party management application 204 determines that a request to join the cluster 112 has not been obtained (block 302: NO), control returns to block 302. If the third party management application 204 determines that a request to join the cluster 112 has been obtained (block 302: YES), the third party management application 204 requests a secret token by transmitting the identity credentials of the requesting non-native node 108A to the sidecar identity provider agent 206 using the non-native protocols (block 304). At block 306, the sidecar identity provider agent 206 determines that a secret token request has been obtained from the requesting non-native node 108A based on the non-native protocol of the third party management application 204. At block 308, the sidecar identity provider agent 206 communicates the identity credentials for the non-native node to the control identity agent 208 using a native or local protocol.

At block 310, the control identity agent 208 requests identity verification from the multi-cluster orchestrator node 104 based on the identity credentials of the non-native node. As further described above, the multi-cluster orchestrator node 104 works with the identity provider node 106 to verify the identity of the requesting non-native node 108A to ensure that the requesting non-native node 108A is authentic and/or legitimate. At block 312, the control identity agent 208 determines if the identity of the requesting non-native node 108A has been verified based on a response from the multi-cluster orchestrator node 104. If the control identity agent 208 determines that the identity of the requesting non-native node 108A has not been verified (block 312: NO), control continues to block 320, as further described below. If the control identity agent 208 determines that an identity of the non-native node has been verified (block 312: YES), the control identity agent 208 requests a secret token from the virtual execution environment orchestrator layer server circuitry 212 (block 314). At block 316, the virtual execution environment orchestration layer server circuitry 212 generates a secret token and provides the secret token to the control identity agent 208. As described above, the requesting non-native node 108A can run a protocol using the secret token to access the virtual execution environment orchestrator layer server circuitry 212 to join the cluster 112. At block 320, after obtaining the secret token from the virtual execution environment orchestrator layer server circuitry 212, the control identity agent 208 forwards the secret token to the requesting non-native node 108A via the sidecar identity provider agent 206 and the third party management application 204. For example, the control identity agent 208 forwards the secret token to the sidecar identity provider agent 206 corresponding to the requesting non-native node 108A. As described above, the control identity agent 208 communicates according to the native protocol and the sidecar identity provider agent 206 can obtain the secret token from the requesting non-native node 108A using the native protocol. The sidecar identity provider agent 206 can communicate the secret token to the third party management application 204 using the non-native protocols and the third party management application 204 can provide the secret token to the requesting non-native node 108A via the network interface circuitry 200 using the non-native protocol. As described above, the requesting non-native node 108A can use the secret token to access the virtual execution environment orchestration layer server circuitry 212, thereby join the cluster 112.

FIG. 4 is a block diagram of an example programmable circuitry platform 400 structured to execute and/or instantiate the example machine-readable instructions and/or the example operations of FIG. 3 to implement the control plane node 102 of FIG. 2. The programmable circuitry platform 400 can be, for example, a server, a personal computer, a workstation, a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the multi-cluster orchestrator node 104, the virtual execution environments 202, the third party management application 204, the sidecar identity provider agent 206, the control identity agent 208, the virtual execution environment orchestration layer control plane circuitry 210, and/or the virtual execution environment orchestration layer server circuitry 212 of FIGS. 1 and/or 2.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 420 implements the network interface circuitry 200 of FIG. 2.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, a keyboard, a button, a mouse, and/or a touchscreen.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIG. 3 to effectively instantiate the circuitry of FIGS. 1 and/or 2 as logic circuits to perform operations corresponding to those machine readable instructions. In some such examples. the circuitry of FIGS. 5 and/or 6 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. However, in some example the L2 cache is connected to each core 502 and the shared memory 510 is implemented by level 3 (L3) cache for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

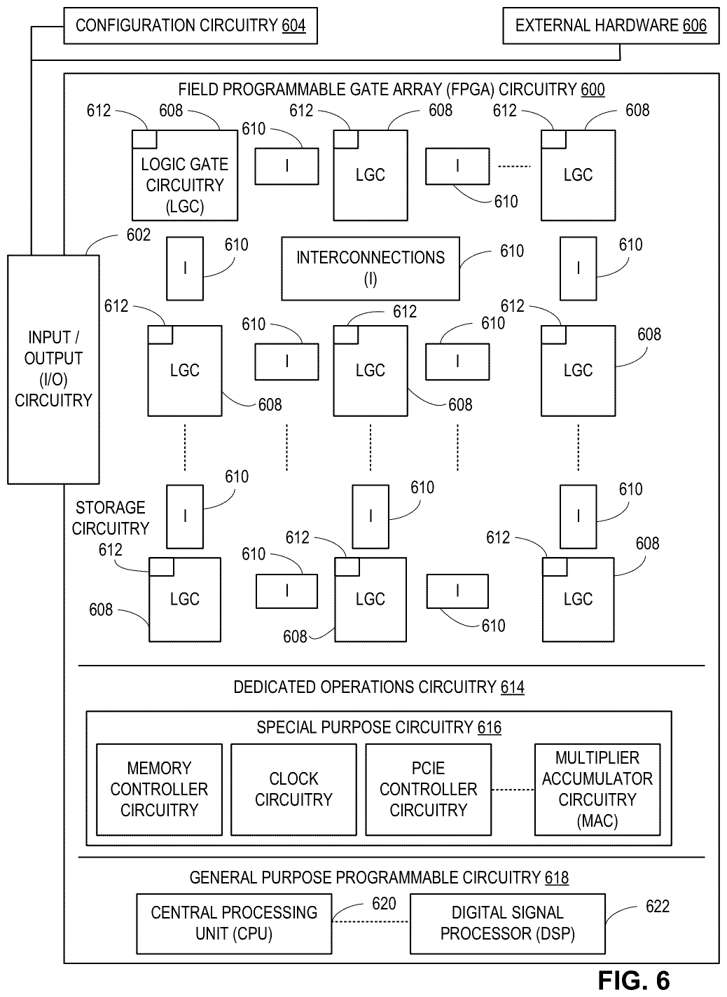

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 600 may be configured and/or structured to effectively instantiate some or all of the operations/functions corresponding to the machine readable instructions of the flowchart(s) of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIG. 3 to perform first operation(s)/function(s), the FPGA circuitry 600 of FIG. 6 may be configured and/or structured to perform second operation(s)/function(s) corresponding to a second portion of the machine readable instructions represented by the flowcharts of FIG. 3, and/or an ASIC may be configured and/or structured to perform third operation(s)/function(s) corresponding to a third portion of the machine readable instructions represented by the flowcharts of FIG. 3.

It should be understood that some or all of the circuitry of FIGS. 5 and/or 6 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIGS. 5 and/or 6 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the processor circuitry 412 of FIGS. 5 and/or 6 may be implemented within one or more virtual machines and/or virtual execution environments executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIGS. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

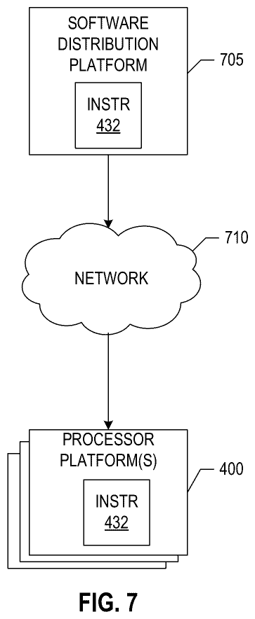

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIG. 3, as described above. The one or more servers of the example software distribution platform 705 are in communication with an example network 710, which may correspond to the network 114 of FIG. 1. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. 3, may be downloaded to the example programmable circuitry platform 400 which is to execute the machine readable instructions 432 to implement the processor circuitry 412. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

Example methods, apparatus, systems, and articles of manufacture to add a non-native node to a cluster are disclosed herein. Further examples and combinations thereof include the following: Example 1 includes a non-transitory computer readable medium comprising instructions to cause one or more programmable circuits to instantiate a first agent to interface with a management application to obtain a request from a node to join a cluster of nodes, the first agent to interface with the management application using a first protocol, and instantiate a second agent which employs a second protocol different than the first protocol responsive to an authentication of an identity credential of the node, obtain a secret credential, and cause the first agent to pass the secret credential to the node via the management application to enable the node to join the cluster of nodes.

Example 2 includes a computer readable medium as defined in example 1, wherein the first protocol is a non-native protocol that is not native to the cluster of nodes and the second protocol is a native protocol that is native to the cluster of node, the first agent to execute the first protocol and the second protocol in a first virtual execution environment, and the second agent to execute the second protocol in a second virtual execution environment.

Example 3 includes a computer readable medium as defined in one or more of examples 1-2, wherein the first agent employs a shared secret to ensure secure communication with the second agent.

Example 4 includes a computer readable medium as defined in one or more of examples 1-3, wherein the second agent exposes a secure API to the first agent to communicate the secret credential.

Example 5 includes a computer readable medium as defined in one or more of examples 1-4, wherein no modification to the node is required to join the cluster.

Example 6 includes a computer readable medium as defined in one or more of examples 1-5, wherein the identity credential is provided via the request from the node to join the cluster, the second agent to forward the identity credential to an orchestrator to authenticate the node.

Example 7 includes a computer readable medium as defined in one or more of examples 1-6, wherein the node is a first node, the secret credential is a first secret credential, the authentication is a first authentication, the identity credential is a first identity credential, and the management application is a first management application, the instructions to cause at least one of the one or more programmable circuits to instantiate a third agent to interface with a second management application to obtain a second request from a second node to join the cluster of nodes, the third agent to interface with the second management application using a third protocol different than the first and second protocols, and instantiate the second agent which employs the second protocol to responsive to a second authentication of a second identity credential of the node second, obtain a second secret credential, and cause the first agent to pass the second secret credential to the second node via the second management application to enable the second node to join the cluster of nodes.

Example 8 i includes a computer readable medium as defined in one or more of examples 1-7, wherein the node corresponds to a third party.

Example 9 includes a computer readable medium as defined in one or more of examples 1-8, wherein the first agent is a container sidecar.

Example 10 includes an apparatus comprising interface circuitry to obtain a request from a node using a first protocol, the request to join a cluster of nodes, computer readable instructions, and programmable circuitry to instantiate a first agent to interface with a management application to obtain the request from a node to join the cluster of nodes, the first agent to interface with the management application using the first protocol, and a second agent which employs a second protocol different than the first protocol to responsive to an authentication of an identity credential of the node, access a secret credential, and cause the first agent to pass the secret credential to the node via the management application to enable the node to join the cluster.

Example 11 includes an apparatus as defined in example 10, wherein the first protocol is a non-native protocol that is not native to the cluster of nodes and the second protocol is a native protocol that is native to the cluster of node, the first agent to execute the first protocol and the second protocol in a first virtual execution environment, and the second agent to execute the second protocol in a second virtual execution environment.

Example 12 includes an apparatus as defined in one or more of examples 10-11, wherein the first agent employs a shared secret to ensure secure communication with the second agent.

Example 13 includes an apparatus as defined in one or more of examples 10-12, wherein the second agent exposes a secure API to the first agent to communicate the secret credential.

Example 14 includes an apparatus as defined in one or more of examples 10-13, wherein no modification of the node is required to join the cluster.

Example 15 includes an apparatus as defined in one or more of examples 10-14, wherein the identity credential is provided via the request from the node to join the cluster, the second agent to forwards the identity credential to an orchestrator to authenticate the node.

Example 16 includes an apparatus as defined in one or more of examples 10-15, wherein the node is a first node, the secret credential is a first secret credential, the authentication is a first authentication, the identity credential is a first identity credential, and the management application is a first management application, the programmable circuitry to instantiate a third agent to interface with a second management application to obtain a second request from a second node to join the cluster of nodes, the third agent to interface with the second management application using a third protocol non-native to the cluster of nodes, and instantiate the second agent which employs the second protocol to responsive to a second authentication of a second identity credential of the node second, obtain a second secret credential, and cause the first agent to pass the second secret credential to the second node via the second management application to enable the second node to join the cluster of nodes.

Example 17 includes an apparatus comprising interface circuitry to obtain a first request from a node using a first protocol, the request to join a cluster of nodes, machine readable instructions, and programmable circuitry to at least one of instantiate or execute the machine readable instructions to obtain the first request from the node to join the cluster of nodes using the first protocol, responsive to an authentication of an identity credential of the node, access a secret credential using a second protocol different than the first protocol, and pass the secret credential to the node to enable the node to join the cluster.

Example 18 includes an apparatus as defined in example 17, wherein no modification to the node is required to join the cluster.

Example 19 includes an apparatus as defined in one or more of examples 17-18, wherein the identity credential is provided via in the first request from the node to join the cluster, the programmable circuitry to forward the identity credential to an orchestrator to authenticate the node.

Example 20 includes an apparatus as defined in one or more of examples 17-19, wherein the node is a first node, the secret credential is a first secret credential, the authentication is a first authentication, and the identity credential is a first identity credential, wherein the interface circuitry to obtain a second request from a second node using a third protocol, the second request to join the cluster of nodes, and the programmable circuitry to obtain the second request from the second node to join the cluster of nodes using the third protocol, responsive to a second authentication of a second identity credential of the node second, access a second secret credential, and pass the second secret credential to the second node to enable the second node to join the cluster.

Example 21 includes an apparatus as defined in one or more of examples 17-20, wherein the programmable circuitry is to, when identity credential of the node is not authenticated, generate an error message.

From the foregoing, it will be appreciated that example systems, apparatus, articles of manufacture, and methods have been disclosed to add a non-native node to a cluster. Examples disclosed herein utilize two agents to convert requests from non-native protocols to native protocols, verify the identity of a non-native node, and distribute keys by converting the native protocols to the non-native protocols. Accordingly, disclosed systems, apparatus, articles of manufacture, and methods allow non-native nodes to enter a native system without forcing the non-native node to install native software to request to join a cluster and/or obtain a secret credential to join a cluster. Disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A non-transitory computer readable medium comprising instructions to cause one or more programmable circuits to:
instantiate a first agent to interface with a management application to obtain a request from a node to join a cluster of nodes, the first agent to interface with the management application using a first protocol; and
instantiate a second agent which employs a second protocol different than the first protocol:
responsive to an authentication of an identity credential of the node, obtain a secret credential; and
cause the first agent to pass the secret credential to the node via the management application to enable the node to join the cluster of nodes.

2. A computer readable medium as defined in claim 1, wherein the first protocol is a non-native protocol that is not native to the cluster of nodes and the second protocol is a native protocol that is native to the cluster of node, the first agent to execute the first protocol and the second protocol in a first virtual execution environment, and the second agent to execute the second protocol in a second virtual execution environment.

3. A computer readable medium as defined in claim 1, wherein the first agent employs a shared secret to ensure secure communication with the second agent.

4. A computer readable medium as defined in claim 1, wherein the second agent exposes a secure API to the first agent to communicate the secret credential.

5. A computer readable medium as defined in claim 1, wherein no modification to the node is required to join the cluster.

6. A computer readable medium as defined in claim 1, wherein the identity credential is provided via the request from the node to join the cluster, the second agent to forward the identity credential to an orchestrator to authenticate the node.

7. A computer readable medium as defined in claim 1, wherein the node is a first node, the secret credential is a first secret credential, the authentication is a first authentication, the identity credential is a first identity credential, and the management application is a first management application, the instructions to cause at least one of the one or more programmable circuits to:
instantiate a third agent to interface with a second management application to obtain a second request from a second node to join the cluster of nodes, the third agent to interface with the second management application using a third protocol different than the first and second protocols; and
instantiate the second agent which employs the second protocol to:
responsive to a second authentication of a second identity credential of the node second, obtain a second secret credential; and
cause the first agent to pass the second secret credential to the second node via the second management application to enable the second node to join the cluster of nodes.

8. A computer readable medium as defined in claim 1, wherein the node corresponds to a third party.

9. A computer readable medium as defined in claim 1, wherein the first agent is a container sidecar.

10. An apparatus comprising:
interface circuitry to obtain a request from a node using a first protocol, the request to join a cluster of nodes;
computer readable instructions; and
programmable circuitry to instantiate:
a first agent to interface with a management application to obtain the request from a node to join the cluster of nodes, the first agent to interface with the management application using the first protocol; and
a second agent which employs a second protocol different than the first protocol to:
responsive to an authentication of an identity credential of the node, access a secret credential; and
cause the first agent to pass the secret credential to the node via the management application to enable the node to join the cluster.

11. An apparatus as defined in claim 10, wherein the first protocol is a non-native protocol that is not native to the cluster of nodes and the second protocol is a native protocol that is native to the cluster of node, the first agent to execute the first protocol and the second protocol in a first virtual execution environment, and the second agent to execute the second protocol in a second virtual execution environment.

12. An apparatus as defined in claim 10, wherein the first agent employs a shared secret to ensure secure communication with the second agent.

13. An apparatus as defined in claim 10, wherein the second agent exposes a secure API to the first agent to communicate the secret credential.

14. An apparatus as defined in claim 10, wherein no modification of the node is required to join the cluster.

15. An apparatus as defined in claim 10, wherein the identity credential is provided via the request from the node to join the cluster, the second agent to forwards the identity credential to an orchestrator to authenticate the node.

16. An apparatus as defined in claim 10, wherein the node is a first node, the secret credential is a first secret credential, the authentication is a first authentication, the identity credential is a first identity credential, and the management application is a first management application, the programmable circuitry to:
instantiate a third agent to interface with a second management application to obtain a second request from a second node to join the cluster of nodes, the third agent to interface with the second management application using a third protocol non-native to the cluster of nodes; and
instantiate the second agent which employs the second protocol to:
responsive to a second authentication of a second identity credential of the node second, obtain a second secret credential; and
cause the first agent to pass the second secret credential to the second node via the second management application to enable the second node to join the cluster of nodes.

17. An apparatus comprising:
interface circuitry to obtain a first request from a node using a first protocol, the request to join a cluster of nodes;
machine readable instructions; and
programmable circuitry to at least one of instantiate or execute the machine readable instructions to:
obtain the first request from the node to join the cluster of nodes using the first protocol;
responsive to an authentication of an identity credential of the node, access a secret credential using a second protocol different than the first protocol; and
pass the secret credential to the node to enable the node to join the cluster.

18. An apparatus as defined in claim 17, wherein no modification to the node is required to join the cluster.

19. An apparatus as defined in claim 17, wherein the identity credential is provided via in the first request from the node to join the cluster, the programmable circuitry to forward the identity credential to an orchestrator to authenticate the node.

20. An apparatus as defined in claim 17, wherein the node is a first node, the secret credential is a first secret credential, the authentication is a first authentication, and the identity credential is a first identity credential, wherein:
the interface circuitry to obtain a second request from a second node using a third protocol, the second request to join the cluster of nodes; and
the programmable circuitry to:
obtain the second request from the second node to join the cluster of nodes using the third protocol;
responsive to a second authentication of a second identity credential of the node second, access a second secret credential; and
pass the second secret credential to the second node to enable the second node to join the cluster.

21. An apparatus as defined in claim 20, wherein the programmable circuitry is to, when identity credential of the node is not authenticated, generate an error message.
